(19) United States
(12) Patent Application Publication
(10) Pub. No.: US 2026/0073350 A1
(43) Pub. Date: Mar. 12, 2026

(54) REAL-TIME ORDER FULFILLMENT MONITORING

(71) Applicant: TOSHIBA GLOBAL COMMERCE SOLUTIONS, INC., Durham, NC (US)

(72) Inventors: John PISTONE, Cary, NC (US); Brad M. JOHNSON, Raleigh, NC (US); J. Wacho SLAUGHTER, Raleigh, NC (US); James L. FRANK, Montreal (CA)

(21) Appl. No.: 18/828,934

(22) Filed: Sep. 9, 2024

(51) Int. Cl. G06Q 10/087; G06Q 20/20; G06Q 30/0601

(52) U.S. Cl. CPC G06Q 10/087; G06Q 20/20; G06Q 30/0633

(57) ABSTRACT

Methods and apparatus for automated order placement and fulfillment monitoring are provided. An order is received from a Point of Sale (PoS) device. One or more items in the order are identified. Responsive to receiving a confirmation of the order, a status of each item, among the one or more items in the order, is monitored. A graphical element rendered in a display interface is updated, the graphical element displaying changes in the status of each item within the order.

### BACKGROUND

For quick-service restaurants offering drive-through services, several major challenges can arise. One occurs at the drive-through kiosk, where orders are primarily placed verbally rather than through self-selection on a screen. This reliance on verbal communication significantly increases the difficulty of accurately confirming the food ordered, as verbal interactions are more likely to cause misunderstandings or errors compared to direct and visual methods of order selection. A second challenge relates to tracking the fulfillment of these orders to ensure that food prepared and packaged accurately match the order lists. Such order tracking becomes more important when multiple orders are prepared concurrently, to confirm that each food item is correctly included in the respective order before handoff. Failing to accurately fulfill drive-through orders may undermine the user experience and reduce the restaurant's overall efficiency.

### BRIEF DESCRIPTION OF THE DRAWINGS

FIG. 1 depicts an example drive-through ordering station, according to some embodiments of the present disclosure.

FIG. 2 depicts an example order tracking system where a camera monitors the preparation of items for different orders, according to some embodiments of the present disclosure.

FIG. 3 depicts an example drive-through checkout station with an interface displaying real-time order status, according to some embodiments of the present disclosure.

FIG. 4 depicts an example method for transcribing drive-through orders from speech to text and tracking order status to generate real-time updates and notifications, according to some embodiments of the present disclosure.

FIG. 5 is a flow diagram depicting an example method for automated order transcription and real-time fulfillment monitoring, according to some embodiments of the present disclosure.

FIG. 6 depicts an example computing device configured to perform various aspects of the present disclosure, according to some embodiments of the present disclosure.

### DETAILED DESCRIPTION

In at least one example, the present disclosure relates to automated order transcription and real-time order fulfillment monitoring. When handling drive-through orders, restaurants may face several challenges. Since drive-through orders are typically placed verbally instead of through self-selection, employees may have difficulty understanding the customer's voice message, potentially causing misunderstandings or errors in placing the order, such as selecting the wrong items, sizes, or requirements (e.g., requesting oat milk but entering whole milk). Additionally, after an order is placed, there is currently no system to monitor the preparation and fulfillment of the order in real time. This lack of tracking can lead to unawareness of whether an order has been completed and if the food items packaged match the order list, resulting in items from one order being wrongly placed in another order's bag or incomplete orders being handed off to customers.

The present disclosure provides methods and systems that automatically transcribe verbal messages for orders into text and generates order lists for customer confirmation, potentially on the drive-through kiosk screen or the user's personal device (if available). Once the order is confirmed, the system may continue to track the fulfillment of the order in real time. In some embodiments, the system may use cameras installed in the restaurant to oversee the preparation process. In some embodiments, based on the video recordings captured by the cameras, the system may use computer vision technology to track food preparation and packaging. For example, the system may identify the employee who is assigned to prepare an order, track her actions to determine each item's status (being prepared or completed), and determine whether items within the same order are packaged into the respective bag. The tracked order details may then be transmitted to a display interface accessible by employees. In some embodiments, the interface may provide real-time updates on the status of each order, which enables employees at the checkout station to monitor progress and promptly address any issues. Upon determining that all items are correctly packaged and the order is ready for handoff, the system may update the display interface, and/or send a notification to the customer's device (if available). The disclosed system streamlines the ordering process through accurate voice-to-text transcription and real-time monitoring of order preparation, therefore significantly improving the overall accuracy and efficiency of the drive-through service.

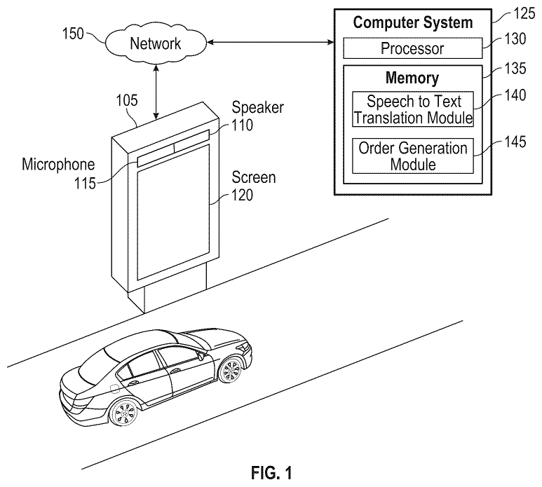

FIG. 1 depicts an example drive-through ordering station 105, according to some embodiments of the present disclosure.

In the illustration, the example drive-through ordering station 105 is located outside a restaurant (or retail store) and comprises three components: a speaker 110, a microphone 115, and a screen 120. These three components, working together, facilitate streamlined communication and interaction between the restaurant staff and the customers when placing orders. In some embodiments, the screen may be configured to display the restaurant's menu. As a customer (or driver) approaches the drive-through station 105, he or she may view the menu displayed on the screen and consider the available options. The customer may then use the microphone 115 to verbally place an order. During the process, restaurant staff may communicate with the customer through the speaker 110, for example, to clarify any details of the order or accommodate any special requests of the customer. The integrated speaker and microphone system facilitates a clear, two-way communication that enables staff and customers to communicate the order effectively.

As illustrated, the drive-through station 105 is further connected to a computing system 125 through a network 150. In some embodiments, the network 150 may be a local area network (LAN) (e.g., Wi-Fi system) and/or a wide area network (WAN) (e.g., Internet). In some embodiments, the drive-through station 105 may record the conversation for order placement between the restaurant staff and the customer. Upon completion, in some embodiments, the drive-through station 105 may transmit the recorded conversation to the speech-to-text translation module 140 within the computing system 125. The speech-to-text translation module 140 may translate the spoken words within the conversation into written text. Utilizing the text, the order generation module 145 may generate a detailed list for the order. In some embodiments, the list may include every ordered item, specifying each item's size, price, any special requirements (such as ingredient substitutions or preparation instructions), and the total price. The order list may provide a comprehensive overview of the customer's selection. The order list may then be transmitted back to the drive-through station 105 (via the network 150) and displayed on the screen 120 for customer review and confirmation. In some embodiments, the customer may confirm the order simply by saying “Confirmed” or “Yes” into the microphone 115. If adjustments are needed, the customer may restate his or her requirements through the microphone 115. The voice data may be automatically transmitted and processed by the speech-to-text translation module 140 and/or the order generation module 145 for updates.

In some embodiments, the speech-to-text translation module 140 may be a software application (or a suite of software applications) that executes on the computing system 125 to convert spoken language into written text. In some embodiments, the order generation module 145 may be a software application (or a suite of software applications) that executes on the computing system 125 to create the detailed order list based on the translated text.

The computing system 125 can be a single computing device (e.g., a server) or a plurality of interconnected computing devices (e.g., a data center or a cloud computing environment). The computing system 125 includes a processor 130 which represents any number of processing elements that each can include any number of processing cores. The computing system 125 also includes memory 135 that stores the speech-to-text translation module 140 and the order generation module 145. The memory 135 may include volatile memory elements, non-volatile memory elements, and combinations thereof.

The computing system 125 that comprises the speech-to-text translation module 140 and the order generation module 145 is described for conceptual clarity. In some embodiments, order placement may be executed using other AI-related techniques (e.g., natural language processing algorithms), or be carried out manually by an employee using conventional methods like paper and pen.

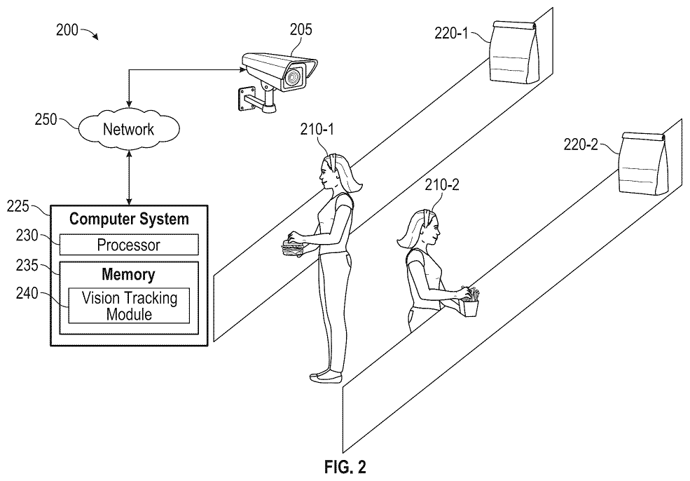

FIG. 2 depicts an example order tracking system 200 where a camera 205 monitors the preparation of items for different orders, according to some embodiments of the present disclosure.

The example order tracking system includes one or more cameras 205 and a computing system 225, both connected via a network 250. In some embodiments, the network 250 may be a local area network (LAN) (e.g., Wi-Fi system) and/or a wide area network (WAN) (e.g., Internet). The camera 205 may be installed within a restaurant in a location that captures the food preparation process (such as the kitchen area). As illustrated, the camera 205 records multiple staff members 210 working concurrently on different orders. For example, staff 210-1 is preparing a fried chicken hamburger for order “0001,” while staff 210-2 is preparing French fries for order “0002.” Upon completion, staff 210-1 should place the hamburger into bag 220-1, and staff 210-2 should put the fries into bag 220-2.

The video footage captured by the camera 205 may then be transmitted in real time to the vision tracking module 240 for further processing and analysis. In some embodiments, the vision tracking module 240 may use computing vision technology to analyze the footage, identify each food item being prepared, and/or attribute the items to the correct orders based on the staff's actions and the bags in which they are placed. For example, the module 240 may identify that staff 210-1 prepared a fried chicken burger and placed it into bag 220-1 for order “0001.” Based on the identification, the module 240 may determine that staff 210-1 is working on order “0001” and the fried chicken burger has been packed. In some embodiments, a bag's 220 association with an order number may be determined by a receipt printed or attached to the bag. The receipt may be captured by the camera 205, and its included order number may be recognized by the vision tracking module 240.

In embodiments where an order includes multiple items, such as order “0001” consisting of a fried chicken burger and a large diet coke, the vision tracking module 240 may track the status of each item (e.g., the burger and the diet coke), categorizing them as not yet prepared, being prepared, and packaged in the bag. The module 240 may then assess the order's completeness once all items within the same order have been correctly packaged.

In embodiments where multiple staff members 210 prepare items for the same order (e.g., order “0001”), the vision tracking module 240 may focus on the interactions with the package bag (e.g., 220-1) for that order. For example, the module 240 may monitor which items are placed into the bag, and update the status of the item (e.g., not yet prepared, being prepared, and packaged) and/or the order (e.g., in progress, completed) accordingly.

In some embodiments, the vision tracking module 240 may verify the accuracy of order fulfillment. For example, if staff 210-1 mistakenly places French fries into bag 220-1, which does not belong to order “0001,” the module 240 may detect the error and send an alert. If staff 210-1 inadvertently moves the bag 220-1 to the ready area before the order is complete, such as order “0001” that includes both a burger and a diet coke but the bag only contains the burger, the module 240, tracking the status of each time in real time, may immediately detect the discrepancy and issue an alert. The real-time order fulfillment monitoring mechanism allows for prompt correction of the mistake to ensure the final order handed to the customer is accurate and complete.

In some embodiments, the vision tracking module 240 may be a software application (or a suite of software applications) that executes in the computing system 225 to track the preparation and fulfillment of each order in the restaurant.

The computing system 225 can be a single computing device (e.g., a server) or a plurality of interconnected computing devices (e.g., a data center or a cloud computing environment). The computing system 225 includes a processor 230 which represents any number of processing elements that each can include any number of processing cores. The computing system 225 also includes memory 235 that stores the vision tracking module 240. The memory 235 may include volatile memory elements, non-volatile memory elements, and combinations thereof.

In some embodiments, the computing system 225 may correspond to the computing system 125 as illustrated in FIG. 1, with the speech-to-text translation module 140, the order generation module 145, and the vision tracking module 240 integrated together within a single computing device. In some embodiments, the computing system 225 may be a separate entity from the computing system 125, and be configured to process the motion tracking data. The computing system 225 may connect to the computing system 125 via the network 150 (or 250) to receive the confirmed order information.

Although the illustrated example order tracking system 200 including one camera 205 is provided for conceptual clarity, in some embodiments, any number of cameras may be installed in the restaurant to monitor the order preparation and fulfillment process. In some embodiments, the camera 205 utilized within the system may be an edge camera, configured with built-in processing capabilities. In such configurations, the camera 205 may receive the confirmed order data directly from the computing system 125 as illustrated in FIG. 1, and/or use its built-in processing power to identify and monitor the status of each order, from preparation to packaging.

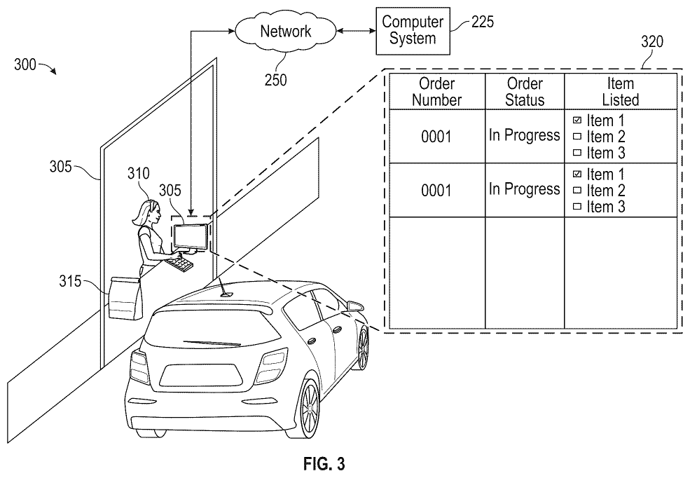

FIG. 3 depicts an example drive-through checkout station 300 with an interface 305 displaying real-time order status, according to some embodiments of the present disclosure.

The example drive-through checkout station 300 has an open window facing the drive-through path, where restaurant staff 310 can easily hand over the prepared order to the customer and/or complete the payment transaction. As illustrated, the drive-through checkout station 300 also includes a display interface 305 and a payment terminal 315. The display interface 305 is connected to the computing system 225 (as illustrated in FIG. 2) via the network 250. Such connections enable the transmission of visual and status data between the computing system 225 and the interface 305.

As illustrated, the interface 305 is configured to display the order status (tracked by the vision tracking module 240 within the computing system 225). The interface 305 organizes the order status information into a clear and structured list 320 that includes three columns: the order number, the order status (labeled as “completed” when all items are packaged or “in progress” if any items remain unpackaged), and the item(s) listed for each order. To enhance clarity regarding the status of individual items, small checkboxes may be placed next to each item name. Each checkbox may serve as a visual indicator of an item's preparation and packaging progress. For example, when an item (e.g., a fried chicken burger) has been prepared and placed into the bag (e.g., 220-1), the corresponding checkbox is marked with a check to indicate its completion. If an item is still in the process of being prepared or has not yet been started, the checkbox next to its name remains unchecked, indicating it is still in the process. In some embodiments, the interface 305 may use a color-coding scheme to provide a more direct visual representation of an item's preparation status, such as using red for items not yet prepared, yellow for items currently being prepared, and green for items fully packaged. Through the checkboxes and/or color-coding scheme, the staff 310 may quickly assess the status of each item within different orders.

In some embodiments, the interface 305 may display package bags prepared for each order, with order status information organized into text boxes adjacent to each bag. These text boxes may show details such as the order number, the order status (labeled either “in progress” or “complete”), and the items included in each order. In some embodiments, each package bag's corresponding text box may not only identify the order but also highlight the completion status of the items within. For example, checkboxes next to each listed item in the text box may serve as indicators of whether an item has been prepared and included in the package. In some embodiments, a checkmark may indicate completion, while an unchecked box indicates the item is still being prepared.

In some embodiments, when an order is complete, the computing system 225 may prompt an on-screen notification on the display interface 305. In embodiments where a customer's contact information is available, the computing system 225 may send a direct notification to the customer's device (e.g., a text message, email, phone call, or push notification). The notification informs the customer and/or staff that the order is ready for pickup.

As illustrated, when errors are detected, such as items placed in wrong bag or an incomplete order mistakenly placed in ready-to-pickup area, the affected order within the list 320 may be highlighted in red or flagged with a warning sign. The alert may serve as an immediate visual reminder for the staff 310 to rectify the mistake before handing the order to the customer.

The display interface 305 acts as a central information hub, providing real-time updates on tracked order status. Through the interface 305, staff may quickly verify the completeness of each drive-through order and rectify any mistakes, such as misallocated items or incomplete orders, before handing over the orders to customers.

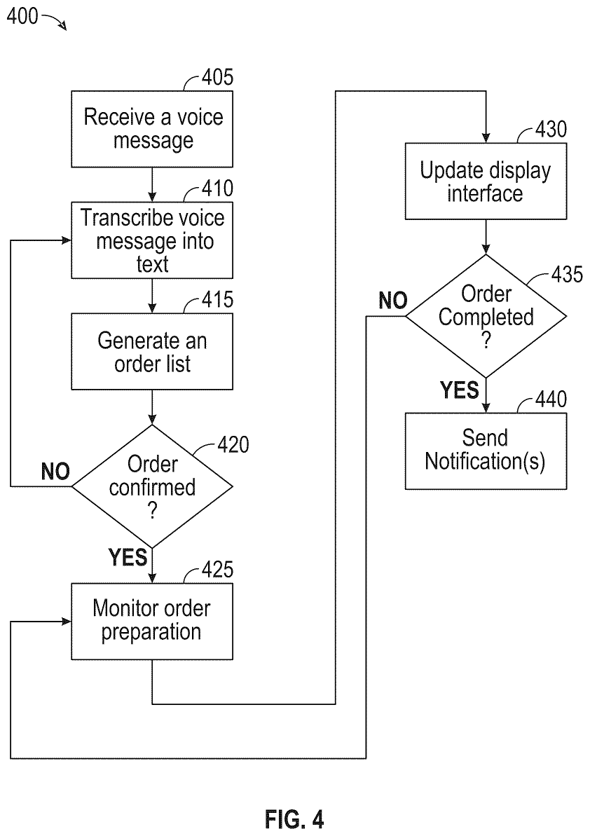

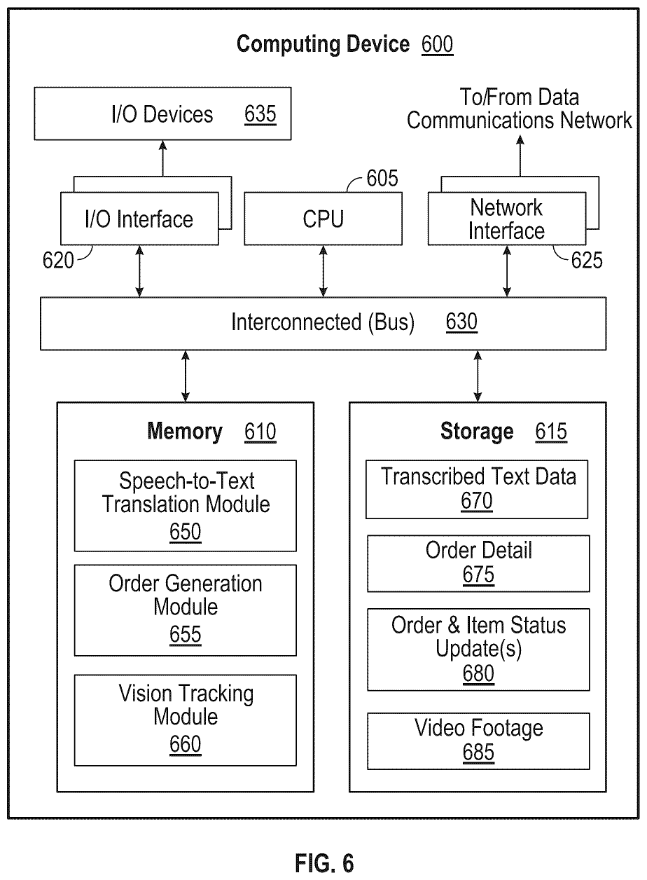

FIG. 4 depicts an example method 400 for transcribing drive-through orders from speech to text and tracking order status to generate real-time updates and notifications, according to some embodiments of the present disclosure. In some embodiments, the method 400 may be performed by one or more computing systems or devices, such as the computing system 125 as illustrated in FIG. 1, the computing system 225 as illustrated in FIG. 2, and/or the computing device 600 as illustrated in FIG. 6.

The method 400 begins at block 405, where a computing system (e.g., 125 of FIG. 1) receives a voice message from a connected drive-through station (e.g., 105 of FIG. 1). In some embodiments, the drive-through station may include a screen (e.g., 120 of FIG. 1), a speaker (e.g., 110 of FIG. 1), and a microphone (e.g., 115 of FIG. 1). When approaching the station, a customer may view the menu displayed on the screen, and speak into the microphone to place an order. The voice data may be transmitted in real-time to the restaurant staff's headset (or a speaker system), allowing them to place the order on behalf of the customer. If the staff have any questions about the order or need further clarifications, they may communicate with the customer through the speaker integrated within the drive-through station. The entire conversation for order placement may be recorded as a voice message and transmitted from the station to the computing system for further processing.

At block 410, the computing system transcribes the voice message into text. The transcription process may involve using speech recognition technology to analyze the voice message and identify words and phrases. After the recognition, the system may then convert these spoken words and phrases into written text. In some embodiments, the system may further conduct context analysis to detect and correct common speech recognition errors. The context analysis may include resolving ambiguities such as homophones (words that sound the same but have different meanings) or clarifying unclear pronunciations.

At block 415, the computing system generates an order list based on the transcribed text. The system may parse the text to identify and extract information about the order, such as item names, quantities, sizes, and any special requests mentioned by the customer (like ingredient substitutions or preparation instructions). Using the parsed information, the computing system may generate a detailed order list. In some embodiments, the order list may include every ordered item along with its specified size, the price for each item, any special requirements attached to each item, and the total price of the order.

At block 420, the computing system checks if the order is confirmed by the customer. In some embodiments, the generated order list may be displayed on the drive-through station's screen (e.g., 120 of FIG. 1) for the customer to review and confirm. If the order is confirmed, such that the customer says “confirmed” or “yes” into the station's microphone (e.g., 115 of FIG. 1), the method 400 moves to block 425. If the customer identifies errors or wishes to add additional items, he or she may speak directly into the microphone to communicate these changes. In such configurations, the method 400 returns to block 410, where the voice message is transcribed into text for modifications or additions to be made to the order.

At block 425, the computing system monitors the preparation of the order in the kitchen (or other processing area). In some embodiments, the computing system may receive live footage of the kitchen area from one or more cameras (e.g., 205 of FIG. 2). The system may use computer vision technology to analyze the captured footage and track order status. For example, using image recognition machine learning (ML) models, the system may identify the food items being prepared by different staff members (e.g., one staff member is preparing a fried chicken burger while another is preparing fries), and determine the package bags designated for different orders (e.g., by recognizing the order number printed or attached to each bag). After items and bags are recognized, the system may attribute each item to the correct order based on ongoing tracking of staff actions. For example, upon detecting that a staff member places a fried chicken burger into the package bag labeled for order “0001,” the system may determine that the staff member is working on order “0001” and the burger has been packaged. The system may then load other information about order “0001,” and continue to track the staff member's actions in preparing other items within the order.

In some embodiments, the computing system may categorize each item's status into three main phases: not yet prepared, being prepared, and packaged. By aggregating the status information of individual items, the computing system may determine the overall status of an order, whether it is still in progress or completed.

In embodiments where multiple staff members prepare items for the same order (e.g., order “0001”), the computing system may focus on tracking interactions with the package bag for that order. If an item, prepared by any staff member, is added to the bag, the system may update the status of the item (e.g., not yet prepared, being prepared, and packaged) and the overall order status (e.g., in progress, completed) accordingly. In some embodiments, if a single staff member (or a defined set of staff members) are assigned to prepare items for a given order, the computing system may evaluate the movements or actions of the defined staff member(s) to track order status.

In some embodiments, the computing system, with its image recognition and motion tracking capabilities, may identify errors in order packaging. For example, based on the tracked item status and the overall order status, the computing system may identify whether items are misplaced into wrong package bag or incomplete orders are mistakenly moved to the ready-to-pickup area. Upon detecting such discrepancies, the computing system may generate alerts or notifications to prompt immediate corrective action by the staff.

At block 430, with the order preparation tracked, the computing system updates a display interface (e.g., 305 of FIG. 3) to show the order status in real time. In some embodiments, the display interface may include a screen installed at the checkout station, the preparation area, or other relevant locations. The screen may provide staff with the latest order details. The configuration allows the staff to monitor the progress of each order in real time and prepare for the final stages of order handover. In some embodiments, the display interface may extend to screens (e.g., 120 of FIG. 1) within the drive-through stations, through which, customers may view the progress of their order as it is being prepared.

At block 435, the computing system checks whether all items in the order have been prepared and are ready to be handed over to the customer. If the order is ready, the method 400 proceeds to block 440. If the order is not ready, the method 400 returns to block 425, where the computing system continues monitoring until completion.

At block 440, the computing system sends a notification to the display interface, informing staff at the checkout station that the order is ready to be handed over to the customer. In some embodiments, the computing system may send a notification to the customer's personal device (via text message, email, phone call, or push notification), indicating that the order is ready for pickup.

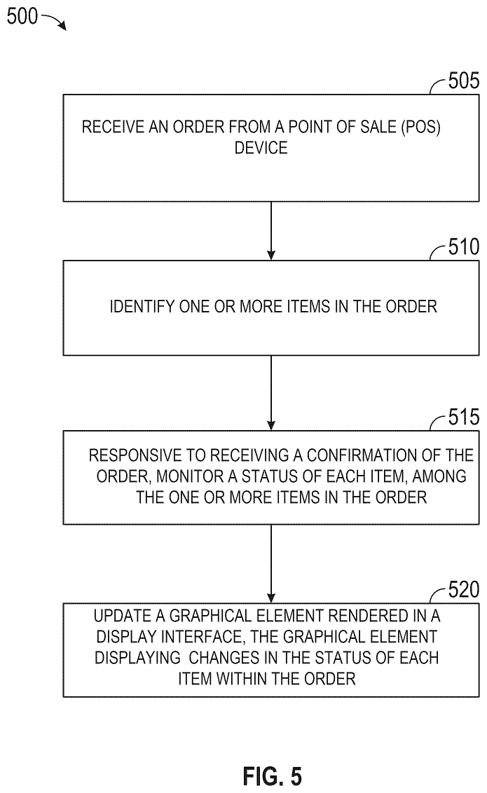

FIG. 5 is a flow diagram depicting an example method for automated order transcription and real-time fulfillment monitoring, according to some embodiments of the present disclosure.

At block 505, a computing system (e.g., 125 of FIG. 1) receives an order from a Point of Sale (PoS) device (e.g., the drive-through station 105 of FIG. 1). In some embodiments, the PoS device may comprise at least one of a drive-through checkout station or a self-checkout station.

At block 510, the computing system identifies one or more items in the order.

At block 515, responsive to receiving a confirmation of the order, the computing system monitors a status of each item, among the one or more items in the order. In some embodiments, the process of monitoring the status of each item may comprise accessing one or more images captured by one or more cameras (e.g., 205 of FIG. 2), and processing the one or more images using one or more object recognition machine learning models.

In some embodiments, the status of each item may comprise at least one of indications that preparation has not been started, preparation is in progress, or preparation is completed.

At block 520, the computing system updates a graphical element rendered in a display interface (e.g., 305 of FIG. 3), where the graphical element displays changes in the status of each item within the order.

In some embodiments, the computing system may further generate an order list based on the plurality of items, and display the order list on a screen (e.g., 120 of FIG. 1) at the PoS device for order confirmation.

In some embodiments, the display interface may show a package bag for the order and a text indicator adjacent to the package bag, where the text indicator comprises at least one of an order number, an order list, and an indication of completeness of the order. In some embodiments, the indication of completeness may comprise at least one of a color-coding scheme or one or more checkboxes to indicate completion of each item within the order or completion of the entire order.

In some embodiments, upon determining the order has been completed, the computing system may send a notification to one or more user devices indicating the order is ready for pickup.

FIG. 6 depicts an example computing device 600 configured to perform various aspects of the present disclosure, according to some embodiments of the present disclosure. Although depicted as a physical device, in some embodiments, the computing device 600 may be implemented using virtual device(s), and/or across a number of devices (e.g., in a cloud environment). The computing device 600 can be embodied as any computing device or system, such as the computing system 125 as illustrated in FIG. 1, or the computing system 225 as illustrated in FIG. 2.

As illustrated, the computing device 600 includes a CPU 605, memory 610, storage 615, one or more network interfaces 625, and one or more I/O interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally considered to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

In the illustrated embodiment, the memory 610 includes a speech-to-text module 650, an order generation module 655, and a vision tracking module 660. Although depicted as a discrete module for conceptual clarity, in some embodiments, the operations of the depicted module (and others not illustrated) may be combined or distributed across any number of modules. Further, although depicted as software residing in memory 710, in some embodiments, the operations of the depicted modules (and others not illustrated) may be implemented using hardware, software, or a combination of hardware and software.

In the illustrated embodiment, the speech-to-text module 650 is configured to convert spoken language into written text. When a customer places her orders verbally through a drive-through station, the speech-to-text module 650 captures the voice message, and uses speech recognition algorithms to transcribe it into text. Following the transcription of the customer's order into text, the order generation module 655 processes the text to extract information about the order, such as item names, quantities, sizes, and any special requests. Based on the extracted information, the module 655 generates a detailed order list that outlines all components of the customer's order in a clear and organized manner. With the detailed order information and the live video footage from cameras installed within the restaurant, the vision tracking module 660 monitors the fulfillment of the orders using computer vision technology. In some embodiments, the vision tracking module 660 may identify food times being prepared, and associate them with the correct orders based on tracking the staff's actions (such as the placement of items into package bags). Utilizing item recognition and real-time motion tracking, the module 660 may track the status of each item (e.g., not yet prepared, in progress, or packaged). By aggregating the status of individual items, the module 660 may then determine the overall order status.

The storage 615 may include a variety of data for the efficient operations of the computing device. In the illustrated embodiments, the storage 615 includes transcribed text data 670 (generated by the speech-to-text module 650), order detail 675 (organized by the order generation module 655), order and item status update(s) 680 (captured by the vision tracking module 660), and video footage 685 (captured by cameras installed in the restaurant for order tracking). In some embodiments, the aforementioned data may be saved in a remote database that connects to the computing device 600 via a network (e.g., Wi-Fi or Internet).

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., order fulfillment tracking application) or related data available in the cloud. For example, the order fulfillment tracking application may perform data processing and generate corresponding instructions through a cloud computing infrastructure, and store the relevant results in a storage location in the cloud. Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving an order from a Point of Sale (PoS) device;
identifying one or more items in the order;
responsive to a confirmation of the order, monitoring a status of each item, among the one or more items in the order; and
updating a graphical element rendered in a display interface, the graphical element displaying changes in the status of each item within the order.

2. The method of claim 1, further comprising:
generating an order list for the one or more items; and
displaying the order list on a screen at the PoS device for order confirmation.

3. The method of claim 1, wherein monitoring the status comprises:
accessing one or more images captured by one or more cameras; and
processing the one or more images using one or more object recognition machine learning models.

4. The method of claim 1, wherein the status of each item comprises at least one of indications that preparation has not been started, preparation is in progress, or preparation is completed.

5. The method of claim 1, wherein the PoS device comprises at least one of a drive-through checkout station or a self-checkout station.

6. The method of claim 1, wherein the display interface shows a package bag for the order and a text indicator adjacent to the package bag, and wherein the text indicator comprises at least one of an order number, an order list, and an indication of completeness of the order.

7. The method of claim 6, wherein the indication of completeness comprises at least one of a color-coding scheme or one or more checkboxes to indicate completion of each item within the order or completion of the entire order.

8. The method of claim 1, further comprising, upon determining the order has been completed, sending a notification to one or more user devices indicating the order is ready for pickup.

9. A system, comprising:
one or more processors;
one or more memories storing a program, which, when executed on any combination of the one or more processors, performs operations, the operations comprising:
receiving an order from a Point of Sale (PoS) device;
identifying one or more items in the order;
responsive to receiving a confirmation of the order, monitoring a status of each item, among the one or more items in the order; and
updating a graphical element rendered in a display interface, the graphical element displaying changes in the status of each item within the order.

10. The system of claim 9, wherein the program, which, when executed on any combination of the one or more processors, performs the operations further comprising:
generating an order list for the one or more items; and
displaying the order list on a screen at the PoS device for order confirmation.

11. The system of claim 9, wherein, to monitor the status of each item, the program, which, when executed on any combination of the one or more processors, performs the operations comprising:
accessing one or more images captured by one or more cameras; and
processing the one or more images using one or more object recognition machine learning models.

12. The system of claim 9, wherein the status of each item comprises at least one of indications that preparation has not been started, preparation is in progress, or preparation is completed.

13. The system of claim 9, wherein the PoS device comprises at least one of a drive-through checkout station or a self-checkout station.

14. The system of claim 9, wherein the display interface shows a package bag for the order and a text indicator adjacent to the package bag, and wherein the text indicator comprises at least one of an order number, an order list, and an indication of completeness of the order.

15. The system of claim 14, wherein the indication of completeness comprises at least one of a color-coding scheme or one or more checkboxes to indicate completion of each item within the order or completion of the entire order.

16. The system of claim 9, wherein the program, which, when executed on any combination of the one or more processors, performs the operations further comprising, upon determining the order has been completed, sending a notification to one or more user devices indicating the order is ready for pickup.

17. One or more non-transitory computer-readable media containing, in any combination, computer program code that, when executed by operation of a computer system, performs operations comprising:
receiving an order from a Point of Sale (PoS) device;
identifying one or more items in the order;
responsive to receiving a confirmation of the order, monitoring a status of each item, among the one or more items in the order; and
updating a graphical element rendered in a display interface, the graphical element displaying changes in the status of each item within the order.

18. The one or more non-transitory computer-readable media of claim 17, wherein the computer program code that, when executed by operation of a computer system, performs the operations further comprising:
generating an order list for the one or more items; and
displaying the order list on a screen at the PoS device for order confirmation.

19. The one or more non-transitory computer-readable media of claim 17, wherein, to monitor the status of each item, the computer program code that, when executed by operation of a computer system, performs the operations comprising:
accessing one or more images captured by one or more cameras; and
processing the one or more images using one or more object recognition machine learning models.

20. The one or more non-transitory computer-readable media of claim 17, wherein the computer program code that, when executed by operation of a computer system, performs the operations further comprising, upon determining the order has been completed, sending a notification to one or more user devices indicating the order is ready for pickup.
